(19) United States
(12) Patent Application Publication
(10) Pub. No.: US 2002/0154670 A1
(43) Pub. Date: Oct. 24, 2002

(54) Electric discharge laser with two-material electrodes

(76) Inventors: Richard G. Morton, San Diego, CA (US); Timothy S. Dyer, Oceanside, CA (US)

Correspondence Address: Cymer, Inc., Legal Department - MS/1-2A, 16750 Via Del Campo Court, San Diego, CA, 92127-1712, US

(21) Appl. No.: 10/081,589

(22) Filed: Feb. 21, 2002

Related U.S. Application Data
(63) Continuation-in-part of application No. 09/953,026, filed on Sep. 13, 2001.
Application No. 09/953,026 is a continuation-in-part of application No. 09/776,044, filed on Feb. 1, 2001.
Application No. 09/776,044 is a continuation-in-part of application No. 09/768,753, filed on Jan. 23, 2001, now Pat. No. 6,414,979.
Application No. 09/768,753 is a continuation-in-part of application No. 09/742,485, filed on Dec. 20, 2000.
Application No. 09/742,485 is a continuation-in-part of application No. 09/703,697, filed on Nov. 1, 2000, now Pat. No. 6,363,094.
Application No. 09/703,697 is a continuation-in-part of application No. 09/590,961, filed on Jun. 9, 2000.
Application No. 09/590,961 is a continuation-in-part of application No. 09/590,958, filed on Jun. 9, 2000.

(51) Int. Cl. H01S 3/223; H01S 3/22

(52) U.S. Cl. 372/55

(57) ABSTRACT

A gas discharge laser having at least one long-life elongated electrode comprised of a first material having a relatively low anode erosion rate and a second anode material having a relatively higher anode erosion rate. The first anode material is positioned at a desired anode discharge region of the electrode. The second anode material is located adjacent to the first anode material along at least two long sides of the first material. During operation of the laser erosion occurs on both materials but the higher erosion rate of the second material assures that any tendency of the discharge to spread onto the second material will quickly erode away the second material enough to stop the spread of the discharge. In a preferred embodiment the anode is as described above and the cathode is also a two-material electrode with the first material at the discharge region being C26000 brass and the second material being C36000 brass. A pulse power system provides electrical pulses at rates of at least 1 KHz. A blower circulates laser gas between the electrodes at speeds of at least 5 m/s and a heat exchanger is provided to remove heat produced by the blower and the discharges.

This invention relates to electric discharge lasers and in particular to such lasers having chambers with long life electrodes. This invention is a continuation-in-part of U.S. Ser. No. 09/590,958, filed Jun. 9, 2000, U.S. Ser. No. 09/590,961, filed Jun. 9, 2000, U.S. Ser. No. 09/703,697, filed Nov. 1, 2000, U.S. Ser. No. 09/742,485; filed Dec. 20, 2000, U.S. Ser. No. 09/768,753, filed Jan. 23, 2001; U.S. Ser. No. 09/776,044, filed Feb. 1, 2001 and U.S. Ser. No. 09/953,026 filed Sep. 13, 2001.

### BACKGROUND OF THE INVENTION

### The KrF Excimer Laser

The principal components of a prior art KrF excimer laser system are shown in FIGS. 1, 2 and 3. The laser system is used as a light source for integrated circuit lithography. These components include a laser chamber housing 2. The housing contains two electrodes 84 and 83 each about 50 cm long and spaced apart by about 20 mm, a blower 4 for circulating a laser gas between the electrodes at velocities fast enough to clear (from a discharge region between the two electrodes) debris from one pulse prior to the next succeeding pulse at a pulse repetition rate in the range of 1000 Hz to 4,000 Hz or greater, and one or more water cooled finned heat exchanger 6 for removing heat added to the laser gas by the fan and by electric discharges between the electrodes. The word “debris” is used here to define any physical condition of the gas after a laser pulse which is different from the condition of the gas prior to the pulse. The chamber may also include baffles and vanes for improving the aerodynamic geometry of the chamber. The laser gas is comprised of a mixture of about 0.1 percent fluorine, about 1.0 percent krypton and the rest neon. Each pulse is produced by applying a very high voltage potential across the electrodes with a pulse power system 8, shown as an electrical circuit in FIG. 3, which causes discharges (between the electrodes) lasting about 30 nanoseconds to produce a gain region about 20 mm high, 3 mm wide and 500 mm long. Each discharge deposits about 2.5 J of energy into the gain region. As shown in FIG. 2, lasing is produced in a resonant cavity, defined by an output coupler 2A and a grating based line narrowing unit (called a line narrowing package or LNP, shown disproportionately large) 2B comprising a three prism beam expander, a tuning mirror and a grating disposed in a Littrow configuration. The energy of the output pulse 3 in this prior art KrF lithography laser is typically about 10 mJ.

This KrF laser light source produces a narrow band pulsed ultraviolet light beam with a wavelength at about 248 nm. These lasers typically operate in a so-called “burst mode” consisting of bursts of pulses at a pulse repetition rate in the range of about 1000 to 4000 Hz. Each burst consists of a number of pulses, for example, about 80 to 300 pulses, each burst illuminating a single die section on a wafer with the bursts separated by off times of a fraction of a second while the lithography machine shifts the illuminating beam between die sections. There is another longer off time of a few seconds when a new wafer is loaded. Therefore, in production, for example, a 2000 Hz, KrF excimer laser may operate at a duty factor of about 30 percent. The operation is 24 hours per day, seven days per week, 52 weeks per year. A laser operating at 2000 Hz “around the clock” at a 30 percent duty factor will accumulate more than 1.5 billion pulses per month. Any disruption of production can be extremely expensive. For these reasons, prior art excimer lasers designed for the lithography industry are modular. The modules typically can be replaced within a few minutes so that maintenance down time is minimized. Laser availability of these lasers are typically higher than 99 percent.

Maintaining high quality of the laser beam produced by these lasers is very important because the lithography systems in which these laser light sources are used are currently required to produce integrated circuits with features smaller than 0.25 microns and feature sizes get smaller each year. As a result the specifications placed on the laser beam limit the variation in individual pulse energy, the variation of the integrated energy of series of pulses, the variation of the laser wavelength and the magnitude of the spectral bandwidth of the laser beam.

### Prior Art Electrodes

Prior art electrodes for the gas discharge lasers referred to above are typically about 50 cm long, may be about 3 cm wide and may have cross section shapes similar to those shown in FIG. 1 at 83 and 84. The actual discharges between the electrodes typically need to be a few millimeters wide (e.g., 3-4 mm) and this need determines the shape of the electrodes. The two electrodes shown produce relatively very high electrode fields over a 3-4 mm wide region in the central region of both of the electrodes (called herein the discharge footprint or discharge surface) to produce approximately rectangles discharges about 3-4 mm in width with a height approximately equal to the electrode spacing and the length of the discharge region is about 500 cm. One problem with these prior art electrodes is that erosion in the approximately 3-4 mm discharge footprint part of both electrodes over several billion pulses causes changes in the cross section shape of the electrode which alters the electric fields which in turn affect the discharge footprint so that the discharge shape is no longer uniform and may become substantially wider, narrower, split or otherwise distorted thereby adversely affecting laser beam quality, and reducing laser efficiency.

Electrode designs have been proposed which are intended to minimize the effects of erosion by providing on the electrode a protruding part having the same width as the discharge. Some examples are described in Japanese Patent No. 2631607. These designs, however, produce adverse effects on gas flow if the protrusion is large and if the protrusion is small, it is eroded away relatively quickly.

### Other Litography Lasers

Other gas discharge lasers used as lithography light sources, very similar to the KrF laser, are the ArF (argon fluorine) laser and the F₂ (fluorine molecular laser).

In the ArF laser the active gases are a mixture primarily of argon and fluorine with neon as a buffer gas, and the wavelength of the output beam is in the range of about 193 nm. These ArF lasers are just now being used to a significant extent for integrated circuit fabrication, but the use of these lasers is expected to grow rapidly. In the F₂ laser, expected to be used extensively in the future for integrated circuit fabrication, the active gas is F₂ and a buffer gas could be neon or helium or a combination of neon and helium. All of these gas discharge lithography lasers utilize similar electrodes although the spacing between them may be slightly different.

What is needed is a gas discharge laser having electrodes which do not adversely affect gas flow and can withstand many billions of electric discharges without substantial adverse effects on laser beam quality.

### SUMMARY OF THE INVENTION

The present invention provides a gas discharge laser having at least one long-life elongated electrode comprised of a first material having a relatively low anode erosion rate and a second anode material having a relatively higher anode erosion rate. The first anode material is positioned at a desired anode discharge region of the electrode. The second anode material is located adjacent to the first anode material along at least two long sides of the first material. During operation of the laser erosion occurs on both materials but the higher erosion rate of the second material assures that any tendency of the discharge to spread onto the second material will quickly erode away the second material enough to stop the spread of the discharge. In a preferred embodiment the anode is as described above and the cathode is also a two-material electrode with the first material at the discharge region being C26000 brass and the second material being C36000 brass. A pulse power system provides electrical pulses at rates of at least 1 KHz. A blower circulates laser gas between the electrodes at speeds of at least 5 m/s and a heat exchanger is provided to remove heat produced by the blower and the discharges.

In preferred embodiments the two-material electrode is an anode of a fluorine containing gas discharge laser. A portion of the anode located at the discharge surface of the anode, is comprised of an anode material containing lead along with other metals chosen to produce during operation a porous insulating layer covering the discharge surface of the anode. The layer is produced by fluorine ion sputtering of the anode surface which creates the insulating layer comprised in part of lead fluoride as well as fluorides of other metals. In a particular preferred embodiment the anode is fabricated in two parts, a second part having the general shape of a prior art anode with a trench shaped cavity at the top. The material for this part such as C26000 brass will be eroded if subject to electric discharge in the normal discharge laser gas environment. A first part comprised of brass having a lead content of greater than 3% is soldered into the trench and protrudes above the surface by about 0.2 millimeter. When the anode is installed in the laser and is subjected to pulse discharges in a fluorine containing laser gas environment an insulating layer, comprising porous lead fluoride, forms on the surface of the first part protecting it from significant erosion. Applicants' computer electric field models have shown that the insulating layer does not significantly affect the electric field between the cathode and the anode. The overall electrode shape is such that there are no significant discharges from the second part at beginning of operation with the electrodes. To the extent discharges do occur from the second part, erosion will occur at the discharge sites reducing the height of the anode in the region of the discharge which has the effect of reducing the discharge from the second part. About 50,000 small holes develop in the insulating layer on the first part which permit electrons to flow freely to and from the metal surface of the anode. However, fluorine ion sputtering on the metal surface of the anode is substantially limited after the insulating layer has developed. Applicants believe that the reduction in fluorine ion sputtering results from a reduced number of fluorine ions reaching the metal surface and a reduction in energy of the ions that do reach the metal surface.

Applicants' tests have shown that the porous insulating layer that covers substantially all of the discharge surface of the anode does not significantly interfere with the electric field between the electrodes and helps control the shape of the discharge making it more spatially uniform over chamber life, as compared to prior art anode designs. This increase uniformity in discharge shape results in greatly improved laser pulse quality over chamber life. Better discharge shape also minimizes the adverse effect of acoustic disturbances within the chamber resulting from reflected acoustic waves from one pulse reflecting back into the discharge region during the immediately following pulse.

Embodiments of the present invention provide decreased burn-in times extended operating lifetimes and improved laser beam quality and beam stability.

### BRIEF DESCRIPTION OF THE DRAWINGS

FIG. 1 shows a cross section of a chamber of a prior-art gas discharge laser.

FIG. 2 shows other features of the prior art laser.

FIG. 3 shows the principal features of a pulse power system of a prior-art gas discharge laser.

FIGS. 4A and 4B show electrical pulse shapes on the FIG. 3 pulse power system.

FIG. 5 is a cross section drawing of a prior art anode.

FIGS.6, 6A, 7A-7E, 9 and 10A show preferred anode cross sections.

FIGS. 8A and 8B show a preferred embodiment of the present invention.

FIG. 10B is a top view of the FIG. 10A anode.

FIG. 11 shows a current return-anode unit.

FIGS. 12A and 12B show cross-sections of aerodynamically designed chambers.

### DETAILED DESCRIPTION OF PREFERRED EMBODIMENTS

Preferred embodiments of the present invention can be described by reference to the drawings.

### Pulse Power Supply System

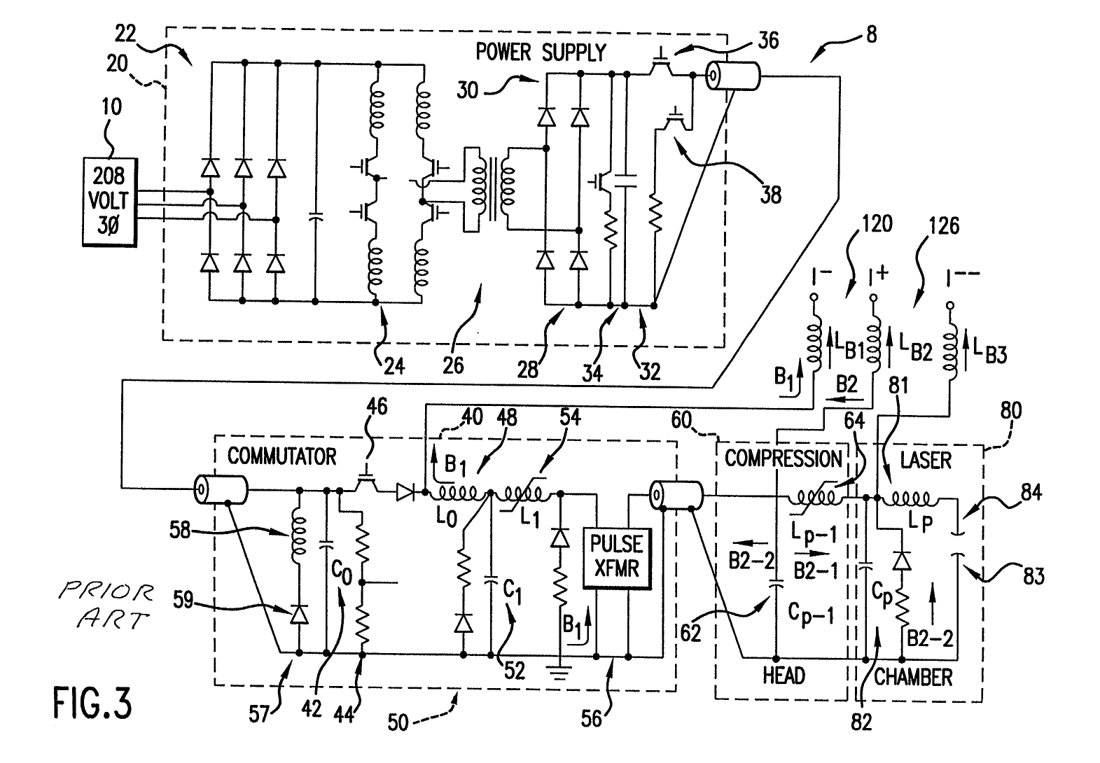

The principal components of an electrical circuit 8 for providing pulse power to produce electrical discharges in a gas discharge laser are shown in FIG. 3. The pulse power system operates from a standard 208-volt, 3 phase electrical source. A power supply using rectifier 22, inverter 24, transformer 26 and rectifier 30 charges charging capacitor C₀ 42 to a voltage level between about 500 to 1200 volts as directed by a laser control processor (not shown). The laser control processor directs the closing of an IGBT switch 46 when a pulse is desired which causes the energy on C₀ to be discharged into the follow-on portions of the pulse power system. The charge on C₀ is transferred successively to capacitor bank C₁ 52 through inductor 48 then through saturable inductor 54 and through voltage transformer 56 to capacitor bank Cₚ₋₁ 62 and then through saturable inductor 64 to peaking capacitor bank Cₚ 82. As shown in FIG. 3, peaking capacitor bank Cₚ is connected electrically in parallel with electrodes 84 and 83.

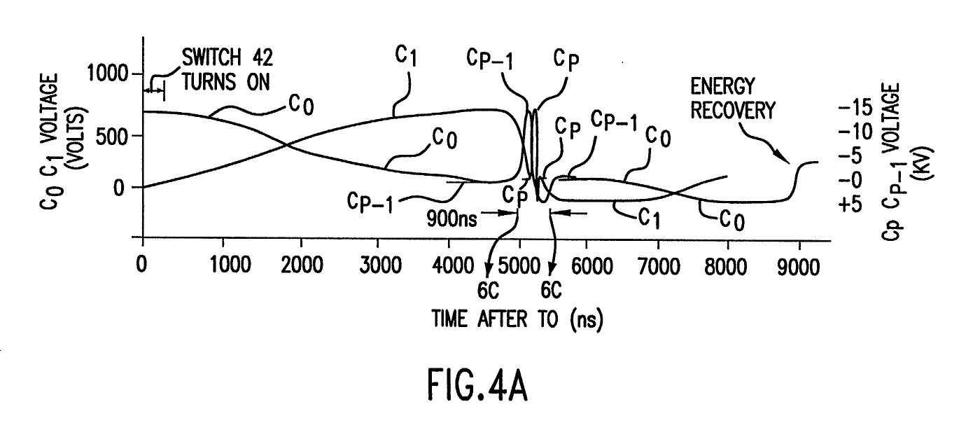

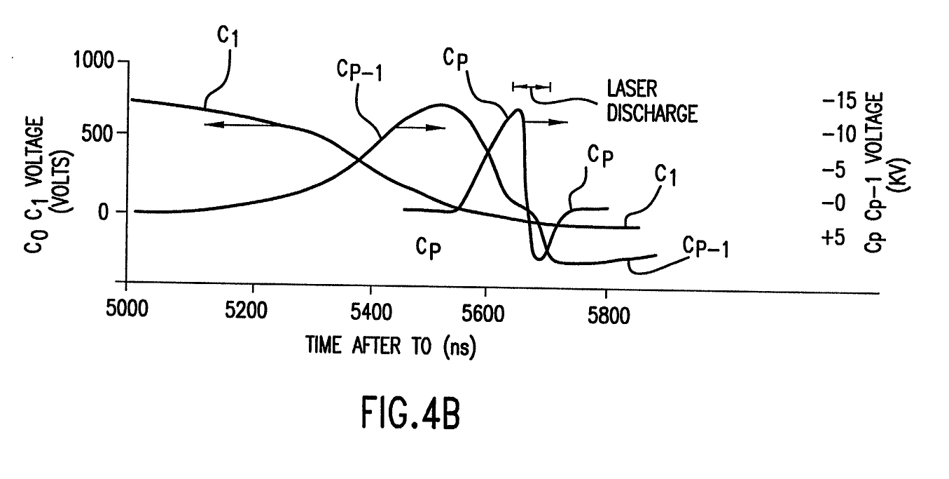

FIG. 4A shows the potential on capacitor banks C₀, C₁, Cₚ₋₁ and Cₚ as a function of time beginning with the closing of switch 42 and for the following 9 microseconds. FIG. 4B shows an 800 ns time slice just before and after the discharge. The reader should note that the peaking capacitor bank Cₚ is charged to approximately −15,000 V just prior to the discharge. The discharge lasts about 30 ns. During the discharge, the electron flow is first from the upper electrode, cathode 84 to the lower grounded electrode, anode 83. A current “overshoot” charges Cₚ to a positive value of about +6,000 V at which time the downward flow of electrons is reversed after which the electron flow is from the lower grounded electrode to the upper electrode during the last approximately 15 ns of the discharge, all as shown in FIG. 4B.

### New Electrode

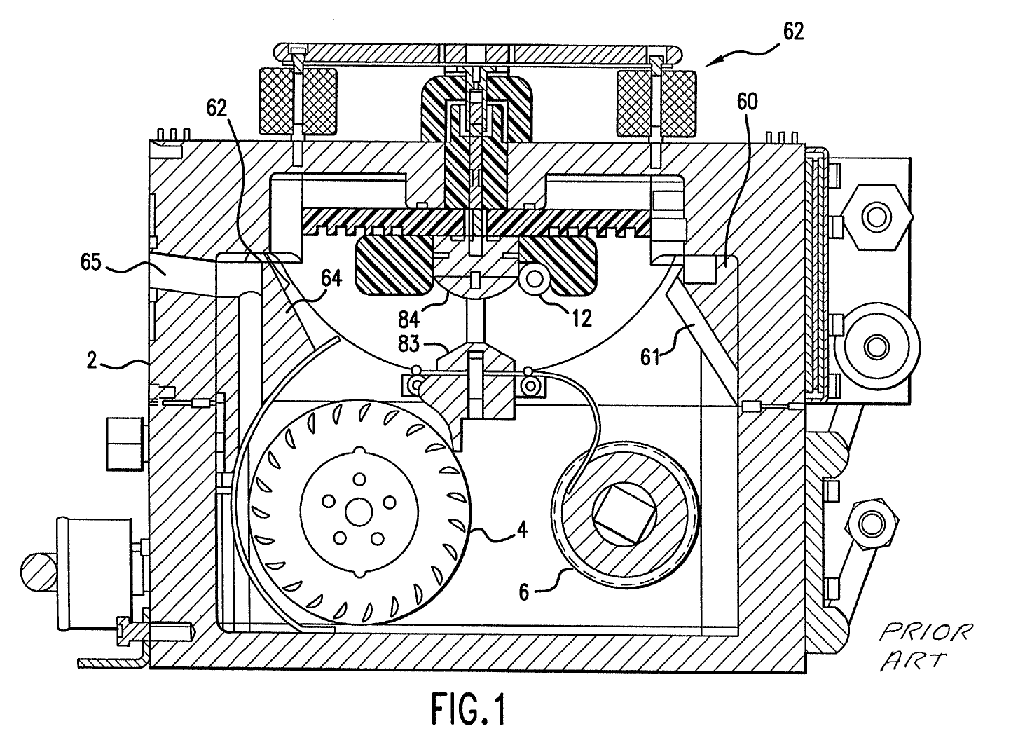

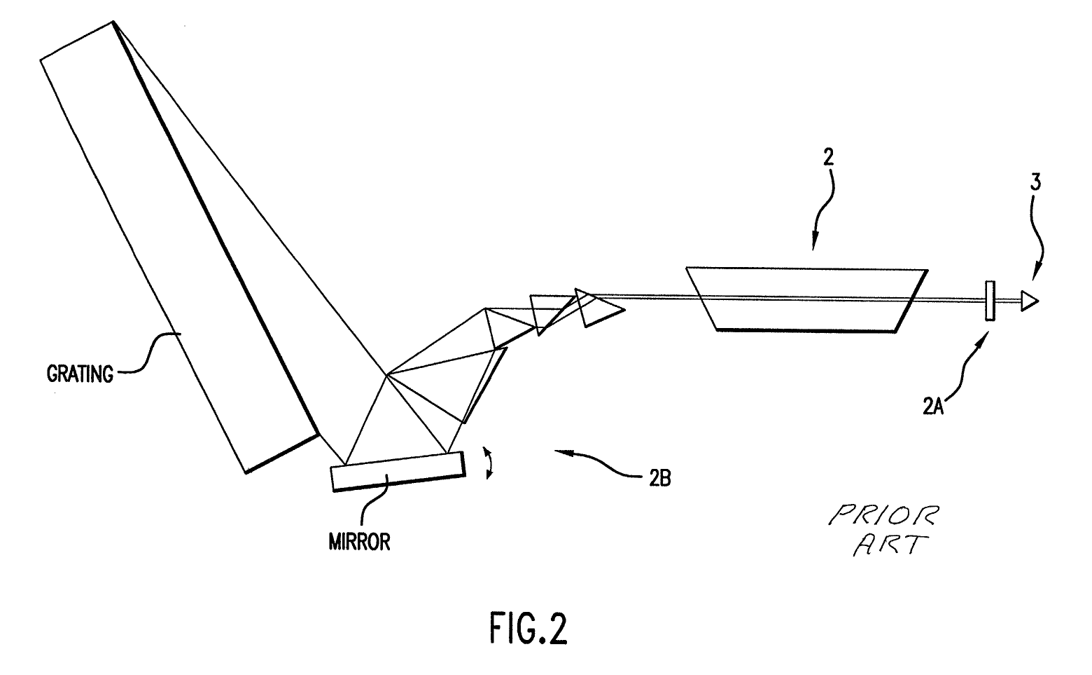

The surface of a newly fabricated prior art brass electrode of the type shown in FIG. 1 is very smooth. However, when viewed under a high power microscope the surface actually is comprised of longitudinal rows running the length of the electrode and spaced apart by about 1 to 2 microns with alternating ridges and valleys, with the bottom of the valleys being about 1 to 2 microns lower than the top of the ridges. The surface under the microscope appears as a long narrow plowed field resulting from machining operations.

### Burnt-In Electrodes

The typical prior art practice when assembling a new laser system or rebuilding a laser chamber is to subject the chamber to a “burn in” phase in which the chamber is operated for about 500 million pulses. At 2000 Hz this requires about 72 hours. During this period, substantial sputtering occurs on the discharge surface of each electrode. The discharge surface is about 3.5 mm wide and about 545 mm long on each electrode. The sputtering occurring on the discharge surfaces of the electrodes and the discharges between the electrodes substantially alters the surface of the electrodes on the discharge portion of the surfaces. The “plowed rows” are no longer apparent after “burn-in” but are replaced mostly by relatively randomly spaced shallow blob indentations typically about 5 microns deep and about 3 to 10 microns wide. These blob-shaped indentations or craters are spaced close together (or slightly overlapping) on the cathode. They are typically somewhat farther apart on the anode so that there are about four times as many per area on the cathode as compared to the anode.

### Erosion

Applicants have discovered that electrode erosion occurs on both electrodes but that the erosion rate of the grounded electrode (anode 83) is about four times that of the high negative voltage electrode (cathode 84). In almost all other gas discharge devices where electrode erosion is a problem, e.g., flashlamps, it is the cathode where most of the erosion occurs. Anode erosion is unusual. Laser operation with brass electrodes can result in an insulating layer of metal fluorides being built up very gradually on portions of the anode. Applicants have discovered that the extent of the fluoride buildup is related to the lead content of the brass anode. For example, an anode comprised of C26,000 brass having less than 1% lead does not produce a significant fluoride layer. However, an anode comprised of C36,000 brass with a 3 to 4% lead content produces a relatively uniform fluoride layer covering the entire discharge surface at a thickness of about 100 to 200 microns. In the regions covered by the fluoride layer, discharge current flows through tiny holes which typically tend to have approximately circular cross sections with diameters of about 20 to 150 microns. The surfaces covered by the fluoride layer do not suffer substantial further erosion, but if the fluoride layer is not uniform the erosion rate is increased on the non-covered discharge surfaces especially if the non-covered surface area decreases. There appears to be some erosion on the covered surfaces at the locations of the tiny holes, but this erosion is at least one, and possible two orders of magnitude less than that of the base metal.

### Erosion Rate

In embodiments of this invention electrodes are comprised of two different materials having erosion rates different from each other. The relatively lower erosion rate material is located at the location of the discharge surface of the electrode which is a long thin surface, for example about 3.5 mm×545 mm. The higher erosion rate material is located along both of the longer sides of the discharge region.

When Applicants, in this specification and the claims, are comparing erosion rates of two materials used in a particular electrode the comparison is based on the materials being subjected to equivalent conditions such as electric fields and currents. The reader should understand that if the low erosion material is subjected to higher fields and discharge currents than the lower erosion material the actual rate of erosion during certain time periods could be higher for the lower erosion material than the higher erosion material. With the electrode designs described herein, however, any such greater erosion of the lower erosion material would reduce slightly the electric field in the region of the lower rate of erosion material relative to the electric fields of the surrounding higher rate of erosion material.

However, any shift in the electric field pattern from the desired electric field pattern toward the surrounding higher rate of erosion material would increase the rate of erosion of the surrounding material which will tend to restore the desired electric field pattern. Therefore, with the electrode designs described herein substantial erosion can occur over may billions of pulses without any substantial change in the electric field patterns and discharge current profiles.

### Sputtered Metal Ions

In order to create a good laser active media, a uniform discharge plasma must be created between the electrodes. Initially the gas in the gap between the electrodes is preionized with preionizer 12 shown in FIG. 1. As the voltage builds up on the electrodes ion sputtering produces plasma in the regions close to the electrode surfaces. Metal atoms sputtered from the electrodes are mostly in vapor form and a substantial portion of the metal atoms are ionized and help form a positive ion cathode “fall” region immediately adjacent to the surface of the cathode creating an extremely large electric field which contributes to the flow of electrons from the cathode and also accelerates electrons leaving the cathode. This process applies first to cathode 84 during the first portion of each pulse. However, because the polarity of the electrodes switch about half-way through the pulse, as shown in FIG. 4B, this effect also occurs at anode 83 which at that time functions as a cathode (i.e., the negative electrode). Both during and after the pulse the metal ions may be attracted back to the electrodes depending on the rapidly changing electric field conditions, but many are blown away by the circulating laser gas because some of the ejected electrode material is transported beyond the gas flow boundary layer. Applicants have discovered that substantial sputtering of copper from the anode is produced by negative fluorine ions during the first portion of each discharge when the anode is highly positively charged.

### Fluoride Layer on Brass Electrode

Applicants have performed extensive testing of various electrode materials in attempts to improve electrode lifetime beyond 10 to 13 billion pulses. With brass electrodes, erosion at the discharge surface of the anode is normally the principal limit of electrode lifetime. Erosion changes the electrode shape from its optimum shape and as a consequence laser beam quality is adversely affected. Applicants' tests with these brass electrodes have shown that the longest lifetime is obtained when materials are used which produce uniform, stable fluoride layers on the discharge surface of the anode. In particular, in one example an anode comprised of C36,000 brass (61.5% copper, 35.5% zinc and 3% lead) produced 13 billion pulses with no degradation in laser performance. (A typical useful operating lifetime for these electrodes is about 5 to 6 billion pulses.) Examination of that anode after the 13 billion pulses revealed a fluoride layer about 100 microns thick covering all of the discharge surface except for about 2 cm long region. This uncovered region faced a portion of the cathode which was severely eroded. Applicants suspect that the erosion of the cathode in this severely eroded region created very high fields which produced very hot discharges which burned off the 2 cm missing section of the anode which lead to the end of life for the cathodes at 13 billion pulses. The fluoride layer is comprised mostly of copper and zinc fluorides but appears to contain other material from the anode including lead. Applicants' measurement of the electrical resistance of the layer confirms it is highly insulating, resistance measurements showing infinity with a hand held ohmmeter.

The insulating layer contains thousands of tiny holes with widths of from about 20 to 150 microns which bottom out on the metal surface of the anode. The holes are spaced at about 20 to 30 holes per square mm on the discharge surface of the anode. The total number of holes in the 3.5 mm×545 mm discharge surface was estimated by Applicants to be about 50,000, and the holes represent about 5% to 10% of the discharge surface area. The other 90% to 95% of the discharge area is comprised of an insulating, dielectric material that can repel negatively charged fluorine ions due to rapid accumulation of negative electronic surface charge.

Applicants have conducted tests with several other types of brass, such as for example C26,000 brass (69.7% copper, 29.6% zinc and less than 0.7% lead) and have determined that the low lead brasses generally do not produce significant fluoride layers in the discharge region of the anode. Applicants' conclusion is that a lead concentration of greater than 1% is needed to produce stable fluoride layers on the anode.

### First Preferred Embodiment

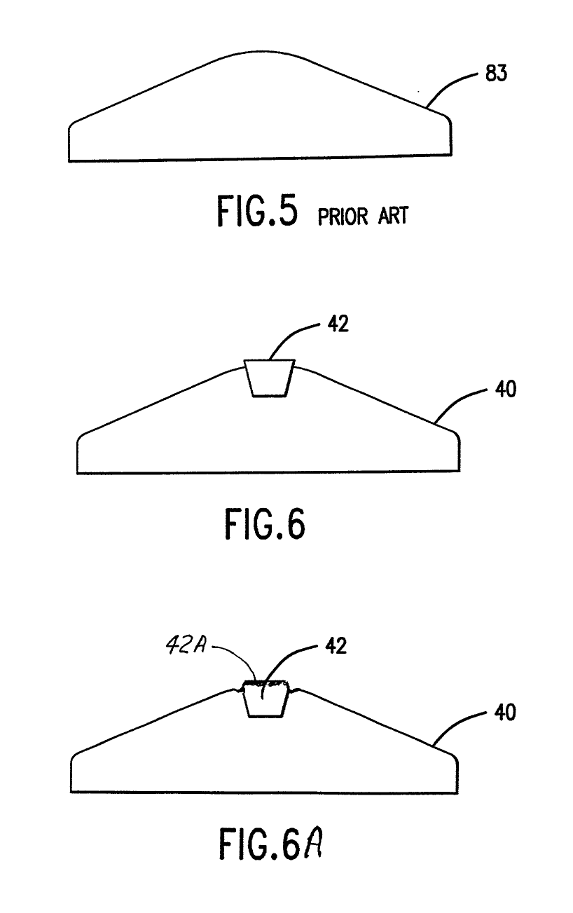

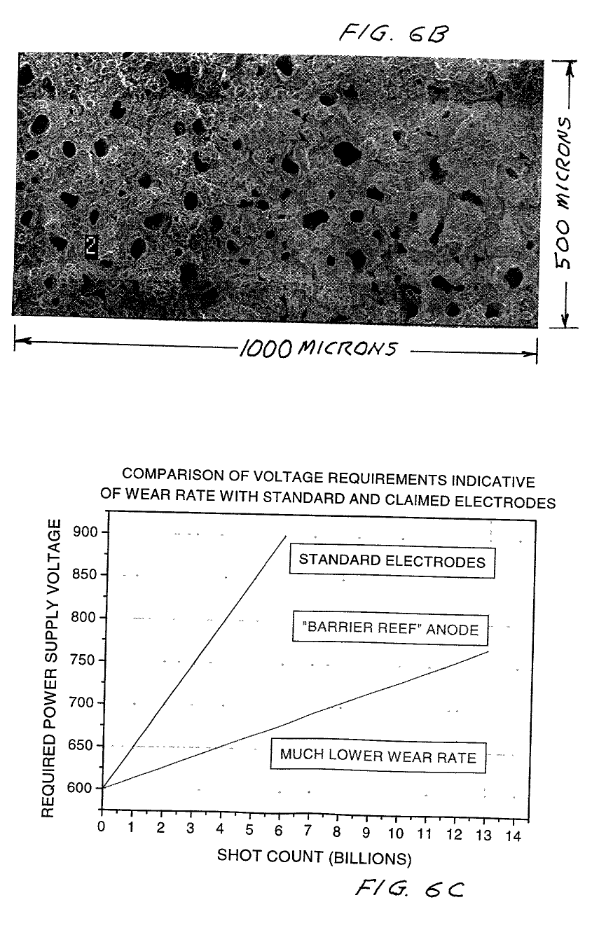

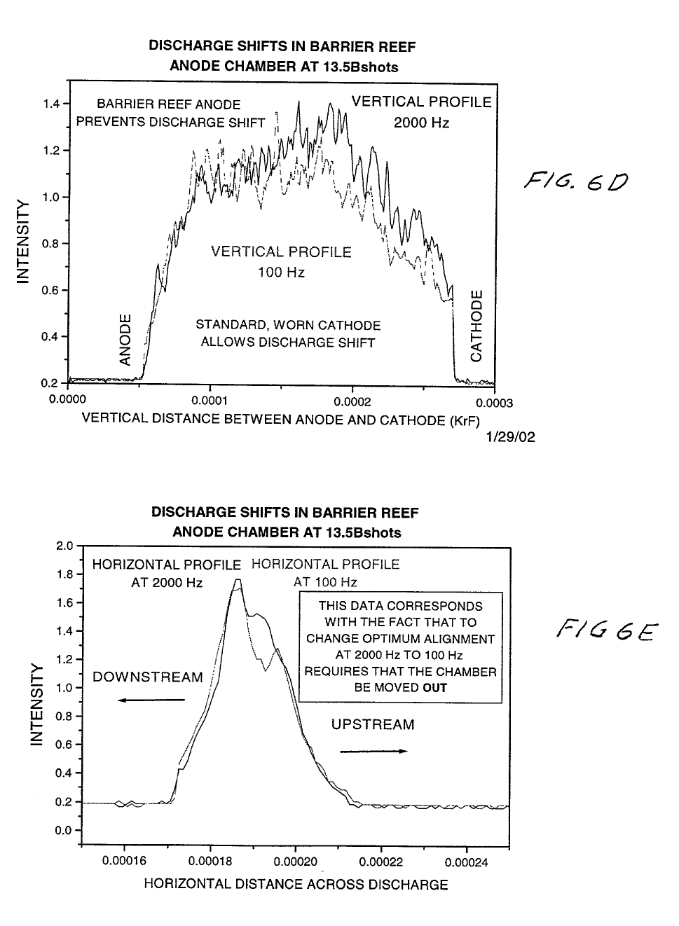

A first preferred embodiment of the present invention is a gas discharge laser such as KrF, ArF or F₂ having an elongated anode with the cross section shown in FIG. 6. The anode is comprised of two types of brass, the main body 40 of the anode 83 in C26000 brass (having a lead content of less than 1%) which is 600 mm long. This anode is a modified version of a prior art anode which has been used extensively in these gas discharge lasers. The prior art 83 anode has a cross section as shown in FIG. 5. The width at the bottom is 1.2 inches. The height to the center tip is 0.380 inch. The tip has a radius of 0.5 inch. The shoulder height from the bottom surface is 0.13 inch. The slanted sides are flat planes at an angle of 27.67 degrees with the bottom surface. Applicants have proven with many laser-years of operation that this general anode shape produces excellent electric field properties and excellent discharge performance along with very good laser gas flow compatibility. In the improved electrode shown in FIG. 5, a trench-shaped cavity is cut into the top surface of anode 83. The cavity is 545 mm long, 3 mm wide at the top, 2.5 mm deep and 1.7 mm wide at the bottom. The cavity is filled with a second brass part 42 comprising of C36,000 brass (having a lead content of about 3 to 4%) which is cut to fit precisely in the cavity and extend above the surface by about 0.2 mm. The second brass part may be bonded in the cavity with Pb/Sn solder.

The anode is installed in a laser such as the one shown in FIG. 1 with, for example, a laser gas consisting of 1% krypton, 0.1% F₂ and the rest neon. A porous fluoride layer, comprising copper fluoride, zinc fluoride and lead fluoride, is created on the top surface of the second brass part 402 shown in FIG. 6 by operation of the laser for about 500 million pulses. At 2000 pulse per second this requires about 3 days. This porous insulating layer which develops, retards erosion of the discharge surfaces which allows the anode to maintain this extremely good shape for may billions of discharges. Electrons flow easily through the approximately 50,000 small holes which develop in the approximately 1,855 square millimeter area (3.5 mm×530 mm) of the lead fluoride layer. (This works out to about 30 holes per square millimeter.) On the other hand, individual fluorine ions, which are far more massive than the electrons, have a low probability of passing through the holes to the underlying brass with sufficient energy to cause sputtering. In one of the parents of this application, Applicants estimate that the present invention will permit at least a doubling or tripling of anode life, so that anode erosion no longer limits laser chamber life. Applicants' subsequent proof testing has supported these predictions. These tests are very time consuming since lasers available for electrode testing produce only about 2500 pulses per second. To accumulate 13 billion pulses at 2500 pulses per second requires a test period of about 60 days. As of the filing of this application a laser chamber with an anode with this initial shape shown in FIG. 6 had accumulated more than 13.5 billion pulses with no significant deterioration of laser pulse quality when it was removed for inspection. Aging of a prior art chamber with a prior art electrode as shown in FIG. 1, causes a reduction in laser efficiency and requires a gradual increase in the fluorine concentration in the laser gas or an increase in the normal discharge voltage to maintain a consistent pulse energy output. Normal practice is to set F₂ concentration for optimum beam quality and to increase operating voltage to compensate for reduced laser efficiency. Chamber lifetime is reached when laser beam quality deteriorates below acceptable levels or when the fluorine concentration and discharge voltage reach design limits.

FIG. 6C is a chart showing power supply voltage (which is approximately proportional to discharge voltage) as a function of chamber lifetime for the test chamber lifetime for the first prototype of the FIG. 6 anode. Also shown on FIG. 6C is a similar graph for a similar chamber with a prior art electrode of the type shown in FIG. 1. As indicated in FIG. 6C, the FIG. 6 prototype lifetime is already more than double the expected lifetime of the prior art anode and based on fluorine and voltage values, anode of this design are expected by Applicants to be capable of continued excellent performance at least to approximately 20 billion pulses. Since the reduction in efficiency evident in the FIG. 6S chart includes the effects of deterioration of parts other than the anode, applicants expect that the useful life of the anode itself may be capable of far in excess of 20 billion pulses. It may even be reasonable to recycle into new chambers anodes taken from a chamber which has reached its end of life.

During the life test of the electrode described above, the Applicants were not able to do a detailed examination of it. However, Applicants have periodically observed the electrodes by removing the LNP and looking at the electrode through the chamber window. The electrode can be observed while the electrodes are discharging at 2,500 Hz. A shield transparent to visible light and opaque to ultraviolet light protects Applicants' eyes. The discharges are described by Applicants as “beautiful” and perfect even after 13 billion pulses. The discharge surface appears basically unchanged since the early formation of a porous fluoride layer at about 500 million pulses. A very shallow trench in the C26000 brass portion sides as shown in FIG. 6A. The protective porous fluoride coating built up on the surface of part 42 is shown at 42A in FIG. 6A. There is no insulating layer built up on the part 40 portion of the anode. Therefore, if the discharge were to extend to the part 40, the discharge would erode a trench at the edge of part 40 which would stop the discharge from that region. Therefore, discharges are limited to the part 42 portion of the anode.

FIG. 6F is a copy of a photograph showing a section of the discharge surface of the prototype anode discussed in detail above. The photograph was taken soon after the anode had been removed from the chamber. The photograph shows the 3.5 mm wide discharge surface covered with the porous fluoride insulating surface. Also evident on the photograph are two solder seems. The photograph shows some accumulation of fluoride material on part 1 on the downstream side of the electrode. This accumulation is very thin and has no effect on electrode performance.

### Importance of Lead

Applicants' tests have demonstrated the great advantages of a small amount of lead content in the copper based electrode material for creating a good stable porous fluoride layer on the discharge surface of the anode. The C36000 brass is a three-phase alloy comprising alpha and beta phases of copper-zinc and separate pure lead clusters. Lead atoms on the surface form fluorides as a result of contact with the fluorine in the laser gas. Applicants suspect that the lead fluoride clusters form nucleation sites on which copper and zinc fluorides accumulate. Lead fluoride is an extremely stable compound, much more stable than copper fluoride and zinc fluoride. Applicants do not have a good explanation as to why the may thousands of small, approximately round holes develop and persist, but they clearly do and they permit approximately 2.5 joules of electric energy to flow through them on each of billions of pulses with greatly reduced anode erosion.

Applicants have shown that excellent performance is achieved with the lead context at about 3-4 percent. A lead content of less than 1% does not produce a stable fluoride layer. Applicants expect good results with the lead content up to about 8 percent but do not at this time have good test data to confirm this expectation.

### Second Preferred Embodiment

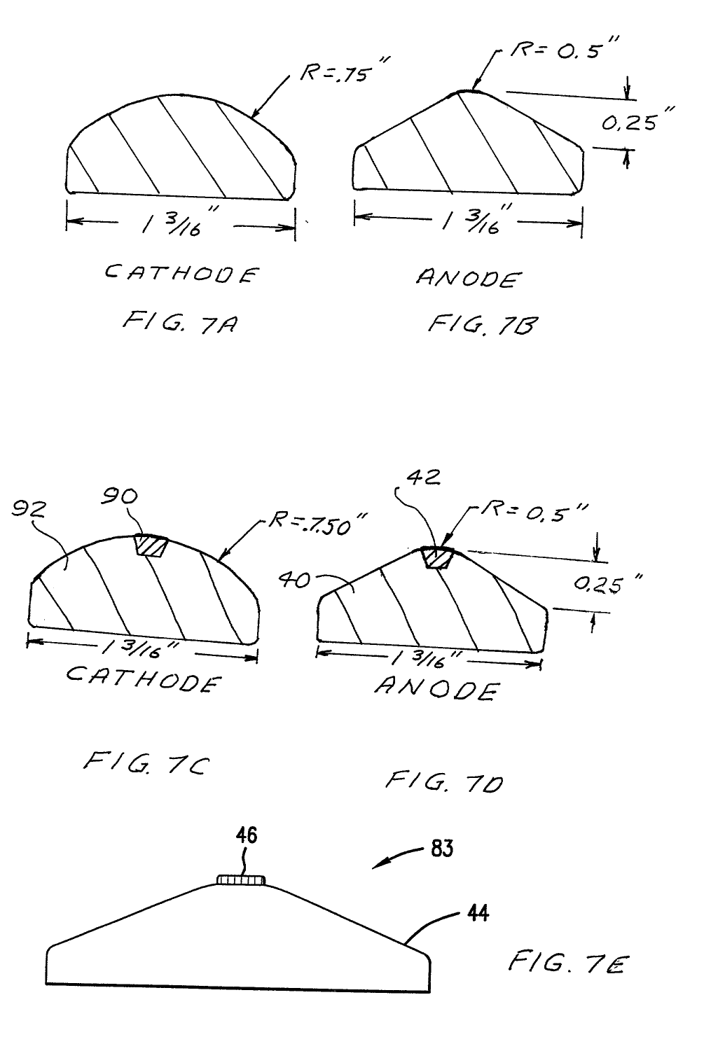

In a second-preferred embodiment of the present invention the anode is as described above and the cathode is similarly comprised of two materials, the first cathode material having a low cathode erosion rate positioned at the desired cathode discharge region and a second cathode material having a relatively higher cathode erosion rate positioned along two long sides of the first cathode material. Applicants have determined through several years of experimenting with brass electrodes that C36000 brass erodes about twice as fast as C26000 brass when used as cathode electrodes in fluorine containing gas discharge lasers. Cross sections of the cathode and anode in this embodiment are shown in FIGS. 7C and 7D respectively. This compares with the single material cathode and anode designs shown in FIGS. 7A and 7B which have been initialized previously in laser chambers designed and built by applicants and their fellow workers.

In the cathode the first material 90 located at the desired cathode discharge region is C26000 0 brass and the second 92 comprises the remainder of the electrode. When used as a cathode neither of these brasses from the porous insulating layer described above; however, the C26000 brass erodes at a rate of about one-half the rate of erosion of the C36000 brass. Therefore, any tendency of the discharge to spread onto the C36000 portion of the cathode will rapidly erode away the C36000 brass in the region of the spread which stops the spread. As explained above, for the anode the first material 42 at the location of the discharge region is C36000 brass and the remainder 40 of the anode is C26000 brass.

### Variation in Annealing

Applicants have determined through experiments that annealing of the brass electrode material can substantially effect cathode erosion rate. In general Applicants have discovered that erosion rate is roughly inversely proportional to grain size over a large range of grain sizes. Since annealing reduces grain size, cathode erosion can be reduced by annealing the material. Therefore, an alternative cathode design would utilize annealed brass as the first material 90 and non-annealed brass as the second material 92. Preferably, sufficient annealing should be provided to reduce the grain size of the second material to about ¼ the grain size of the first material, for example, 54 microns for the first material and 13 for the second material.

### Anodized Layer on Discharge Surface

A cross-section of an anode of a second preferred embodiment is shown in FIG. 7. Porous layer of insulating material 46 such as is placed over the discharge surface of a prior art anode before the anode is assembled in the laser chamber. The base 44 anode is C26000 brass which contains less than 1% lead. Therefore, as in the above no insulating layer will be created by any discharge that extends beyond the limit porous layer 46 and in fact any discharge extending to that region will tend to erode the C26000 brass terminating the discharge in that region and confining discharges to porous insulating surface 46. A preferred porous insulating surface can be provided using an anodizing process such as that discussed with respect to the next two embodiments.

The porous oxide grows on aluminum in a process called anodization. High purity aluminum foil is mounted on the brass electrode. The brass electrode serves as an anode in an electrochemical cell. Generally, the purpose of the anodization is to produce a uniform protected alumina film on the anode. Using appropriate electrolytes and working voltage, the etching leads to production of the self organized porous structure. Holes with diameters from 10 to several hundred microns can be produced by varying the parameters of the anodization process. The thickness of the layer can be up to several hundred microns, but a thickness of about 100 to 1000 microns is preferred for the present application. This layer can be applied as layer 46 as shown in FIG. 7E. An alternative approach is to utilize aluminum for the electrode base material instead of brass. This simplifies the anodization process.

### Porous Alumina on C36000 Brass Insert

In a third preferred embodiment as shown in FIG. 9, the top surface 44 of part 42 which is C36000 brass shown in FIG. 6 is coated with the porous alumina before part 42 is soldered into the cavity of part 40 which is C26000 brass. In this embodiment, the C36000 brass will form a protective fluoride layer in a section if the porous alumina erodes away.

### Tiny Insulating Particles

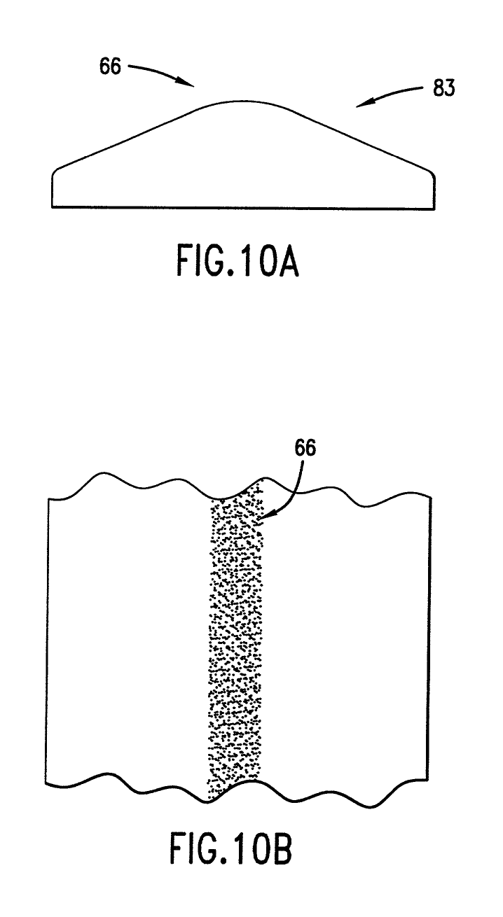

In a fourth preferred embodiment, tiny insulating particles 66 about the shape of grains of sand with dimensions of about 100 to 300 microns are braised to the discharge surface of a prior art brass electrode having the cross section shape shown in FIGS. 10A and 10B. In this embodiment, the discharge width is 3.5 mm. Preferably, the particles cover about 95% of the surface area of the cover about 95% of the surface area of the discharge surface as indicated in FIG. 10B which shows a top view of section of the anode.

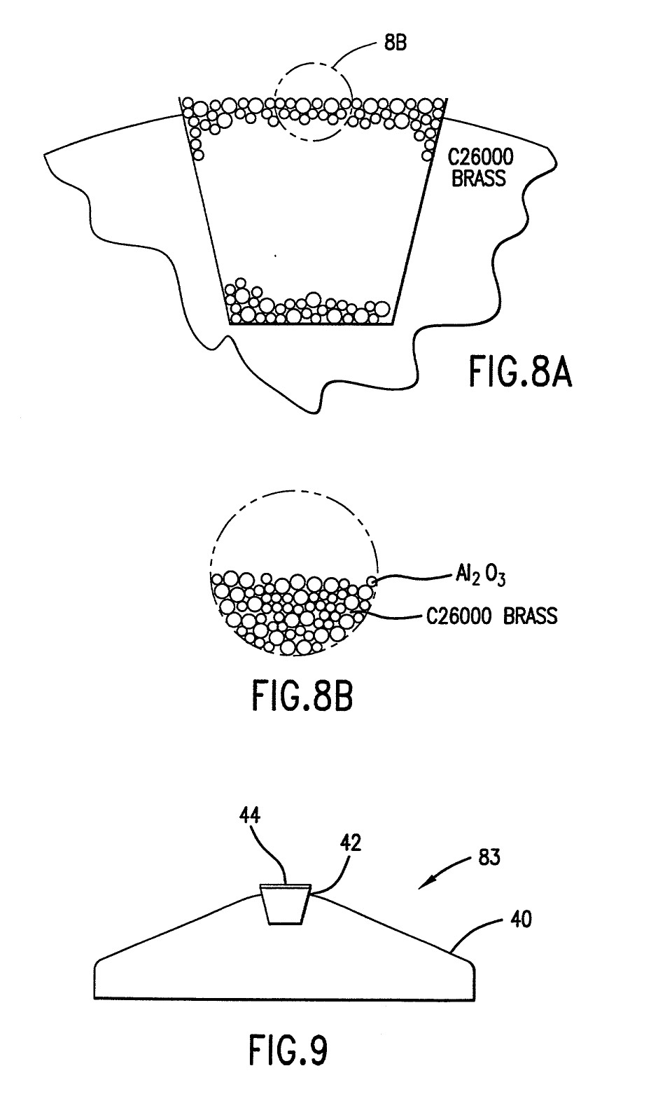

In a similar embodiment the tiny insulating particles such as Al₂ O₃ are mixed with molten brass such as C26000 brass and the mixture are molded into the shape of part 42 as shown in FIG. 6. The resulting part is then machined to fit precisely into a part such as part 40 as shown in FIG. 6. Preferably, the particle sizes are 20 to 150 microns and the particle should constitute about 80-90 percent of the volume of the mixture. After a few days of operation, the surface brass will sputter away leaving an insulator layer on the surface but the material will continue to be conductive below the surface. FIGS. 8A and 8B are drawings showing the electrode surface after the surface brass has been sputtered away. The particles should be of a material which is stable at the melting point of brass and resistant to fluorine chemical reaction. Good choices are Al₂0₃, CaF₂ and MgF₂. The composite shown in FIG. 8A could also be formed using powder metallurgy techniques such as hot or cold pressing.

### Other Fluoride Layers

As explained above Applicants have produced an anode (with C26000 brass and C36000 brass discharge insert) providing an amazing discharge laser lifetime extension. This embodiment increases anode lifetime so that it no longer contributes to chamber lifetime. Other components such as blower bearings now determine chamber lifetime. In the event these other components are in the future improved to extend their lifetime then even further improvement in the anode lifetime may be called for. Confirming whether or not a change in electrode design improves lifetime is a difficult expensive task since the only real proof of improved lifetime is lifetime tests which require months of operation of expensive lasers.

Applicants believe that it is probable that there are alloys other than the combination of C26000 and C36000 that would produce anodes even superior to the ones described above. Also, it is probably possible to create better porous insulating layers with different gas mixtures in lieu of the operating gas mixtures for the lasers in which the electrode will be used. Therefore an embodiment of the present invention is a special technique for creating passivation layers on gas discharge laser electrodes.

### Electrode Passivation Layer Techniques

A fifth preferred embodiment of the present invention requires a construction of a special chamber for electrode passivation. Preferably this chamber may be a used or modified laser chamber specially adapted for producing electrodes with passification layers. Alternatively, a larger chamber could be provided with facilities to passivate several electrodes simultaneously. To determine if there are better alloy combinations than those disclosed above, experiments with alloys of varying combinations of elements should be conducted. For example, brass alloy combinations with various concentrations of copper, zinc and lead should be tested. Other elements such as tin should be tested. In one embodiment a single electrode with several segments, each with different alloy combinations could be tested to determine which produces the best passification layer. By tuning the composition of the electrode, microstructure (Pb segregation), chamber fluorine concentration, electrode potential, and current density, manipulation of the growth rate, thickness, and porosity of the passivating coating should be possible. Passivation can also be conducted inside, or outside the laser chamber using such a custom built apparatus. In the past, the porous fluoride insulating layer would sometimes form and sometimes not. By creating a custom alloy composition, experimenters can promote growth of the fluoride layer in a regular manner. This can be done by tuning both metallurgical factors and material composition (given constant current conditions). Applicants' test data so far has shown that Cu, Zn, and Pb are important to the formation and resulting structure of the passivating “reef” formed during fluorine attack. By increasing the Pb content of the alloy, reef formation can be promoted. This is likely due to increasing the number of nucleation sites for PbF₂ growth, what applicants believe to be the nucleation mechanism of the reef. Zn likely plays a roll in increasing the reef volume since it does not form vapor phase byproducts when attacked by fluorine, however it does fluoridize preferentially to Cu. Chemical analysis of the reef demonstrate that the reef consists of mostly Cu and Zn. To be more specific, CuF₂, ZnF₂, and nucleation sites of PbF₄. Since Sn forms many stable vapor phases fluorides, we can likely tune reef porosity (electrical impedance) by altering the Sn content in the parent alloy. In addition, reef formation kinetics may be altered by changing the metal grain structure via annealing. Applicants have shown that during annealing Pb segregates in high lead Cu alloys, likely creating bigger nucleation sites for the reef. There will be an interplay with the parent material grain size, Pb content, and annealing state on the growth of the passivating reef. By using a statistical optimization software package, passivating reef volume, porosity, and surface coverage of the anode could be optimized. The trade off here is electrical impedance of the passivating layer vs. corrosion protection. In addition, this impedance may impact growth of the reef since F- migration through the coating regulates growth rates at least during the early stage of reef formation. Applicants have observed this in experiments and also know that current density (higher, the better) will also influence the reef formation.

### Plasma anodization process variables include:

A. Pb content: Reef Thickness, nucleation/coverage, and morphology (roughness)

B. Sn content: Reef Porosity

C. Zn content: Reef thickness and morphology.

D. Cu content: Reef thickness

E. Parent Material Grain size: Reef morphology, nucleation/coverage

F. Ion current: Higher, thicker the reef

G. System Voltage

H. Photon Production, enhances fluoride generation

I. F2 concentration: relationship needs to be determined

J. Parent metal surface roughness (Nucleation depends on absorbed F2)

### Flow Shaping

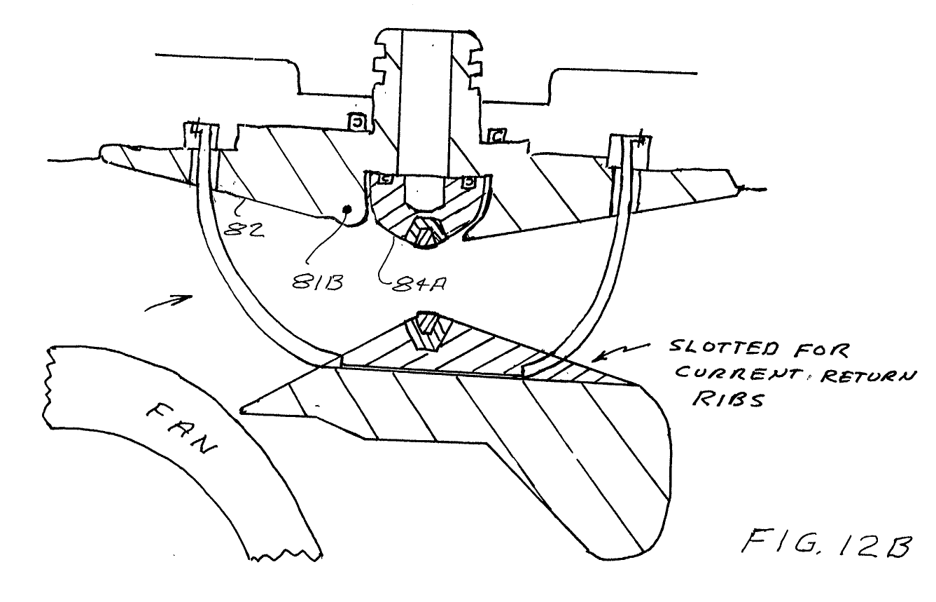

For these gas discharge lasers it is necessary to provide laser gas circulation sufficient to remove from the discharge substantially all of the debris produced during a discharge prior to the next succeeding pulse. Lasers currently in production operate at pulse rates of 4000 Hz which means that the discharge region about 4 mm wide must be cleared during the 1/4000 second 0.25 millisecond between pulses. This requires a gas speed between the electrodes of at least 16 m/second (about 58 kilometers/hour). Future plans are for 6,000 Hz to 10,000 Hz lasers. These speeds in the range of 100 kilometers per hour will require a very aerodynamic by designed discharge region. FIG. 12A shows a design with improved flow shaping in which the components in the discharge region are modified slightly to provide a substantial improvement in aerodynamic parameters. In this case the preionizer 12A has a non-cylindrical shape and ground rod 12A1 is shaped to encourage electron accumulation at the bottom surface. FIG. 12B shows another aerodynamic design in which the preionizer is built into the main insulator to improve design for a major improvement in the aerodynamics. The preionizing element is produced by ground rod 81B inserted into main insulator 82 both of which run parallel to and along the entire lengths of the electrodes. Preionization is produced at the beginning of the pulse by high energy electrons tracking from the base of cathode 84A along the surface of insulator 82 and attempting to reach ground rod 81B. The tracking electron generate high energy ultraviolet photons and soft x-rays which ionize gas in the discharge region in order to encourage electric discharges early in the electric pulse cycle.

### Current Return

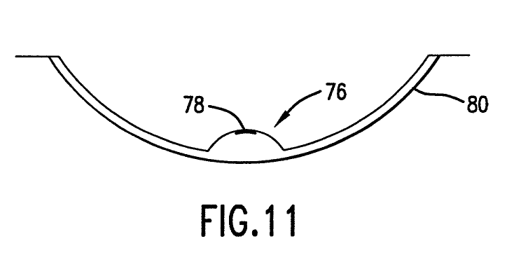

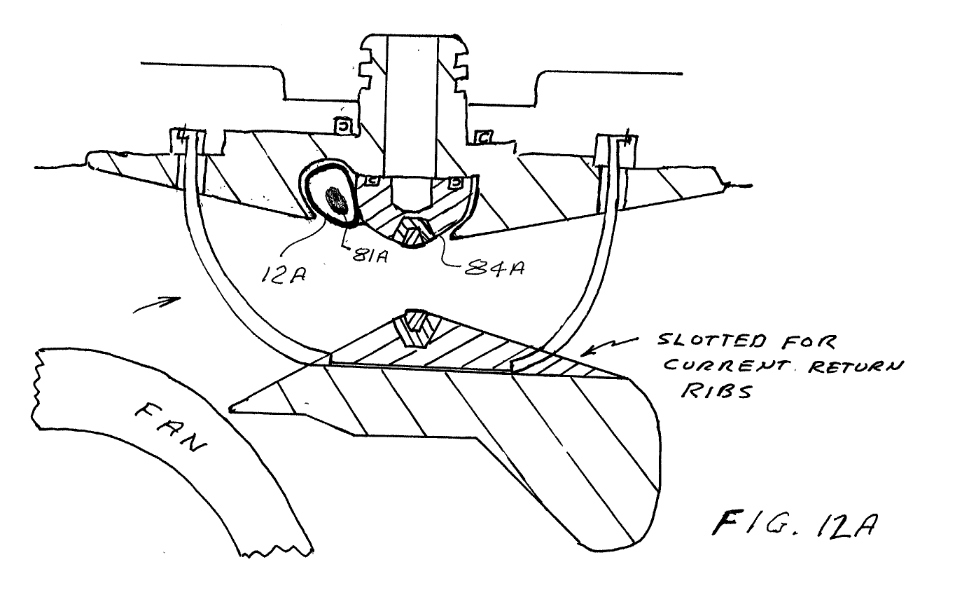

In another preferred embodiment, the current return for the laser is fabricated into a shape as shown in FIG. 11. In this case, the center portion of the current return 76 has a cross section similar to the cross section of a prior art anode so as to produce a very high electric field along the center of the structure. This very high electric field is about 3.5 mm wide defining a discharge region about 3.5 mm wide and the field decreases very sharply on both sides of the discharge region. A porous insulating layer 78 is created covering the discharge region. This layer can be created using any of the techniques described above. This current return may be machined from brass. The discharge surface may be C36000. The preferred embodiment current return has about 40 whale-bone shaped structures 80 on both sides. The top of the current return bolts to the top of the chamber and the electrode portion may be bolted to a stiff electrode support. As with the other embodiment of this invention the current return material is chosen so that material on both sides of the 3.5 mm wide discharge surface erodes faster than the material forming the discharge surface.

### Porous Coating for Cathode Discharge Surface

Until now cathode erosion in these gas discharge lasers has not been considered a problem since the anodes have eroded at about four times the rate of the cathodes. In a preferred embodiment cathode discharge surface is also covered with a porous insulating material. The reader should understand that a lead fluoride layer will not develop naturally on the cathode because the cathode repels negatively charged fluorine ions during the main portion of the discharge pulse time. However, a coated cathode could be produced in an F₂ environment with the cathode operating as an anode. Also, the other techniques described above for providing the porous insulating layer for the anode could be used to produce cathodes with porous insulating layers covering the discharge region. Those layers would protect the cathode from position ion bombardment in the same manner as the described anode protective layers shield it from negative fluorine ion bombardment. As above, material on both sides of the discharge surface erodes faster than the material on the discharge surface.

While the invention has been described above with specificity in terms of preferred embodiments, the reader should understand and recognize that many changes and alterations could be made without deviating from the spirit of the invention. As indicated above the two electrode materials may be selected such that erosion rates of the first material is about ¼ to ½ that of the second electrode material but second materials with erosion rates very high (such as 10 to 20 times higher) compared to the first material could be used. This would assure that any tendency of the beam to spread would be quickly eliminated. It is important to maintain good flow conditions in the gap between the electrodes to clear the gap of discharge debris prior to the next pulse. The width of the porous insulating layer should preferably correspond to the width of the discharge surface which preferably is about equal to the desired width of the laser beam or slightly larger than the beam width. The thickness of the insulating layer should preferably be between about 20 microns and 300 microns with a most preferred range of about 50 to 150 microns. However, the thickness of some of applicants' test anodes have ranged up to about 1 mm without causing serious problems. Two trenches could be provided along both edges of the discharge surface where the electrodes are fabricated. This avoids having the trenches develop naturally during operation of the laser due to erosion. Therefore, the scope of the invention should be determined by the appended claims and their legal equivalents.

We claim:

1. A gas discharge laser comprising:
A) a laser chamber containing a laser gas said laser gas comprising fluorine,
B) two long life elongated electrode elements defining a cathode and an anode, each of said cathode and anode having a long narrow discharge region having a predetermined width chosen to define width of electric discharges between the electrode elements, said anode being comprised of:
1) a first anode material, defining a first anode erosion rate, located at said long narrow discharge region of said anode said discharge region defining two long edges, and
2) a second anode material located on at least two sides of said long narrow discharge region of said anode along said two long edges and adjacent to said long narrow discharge region of said anode,
wherein said first and second anode material are chosen such that the second anode erosion rate is at least 0.50 percent greater than the first anode erosion rate,
C) a pulse power system for providing electrical pulses at rates in excess of 1000 pulses per second to produce said electric discharges,
D) a blower system for circulating said laser gas between said two electrodes at a velocity sufficient to remove substantially all debris produced by a discharge prior to a next subsequent discharge when operating at pulse rates in excess of 1000 pulses per second,
E) a heat exchanger having sufficient capacity to remove heat from said laser gas produced by said blower system and said electric discharges,
wherein during operation of said laser, greater erosion rate of said second anode material prevents any substantial long-term widening of said width of said discharges.

2. A laser as in claim 1 wherein said first anode material in C36000 brass and said second anode material is C26000 brass.

3. A laser as in claim 1 wherein said first anode material is a brass containing at least 1 percent lead.

4. A laser as in claim 1 wherein said first anode material is brass containing at least 3 percent lead.

5. A laser as in claim 1 wherein said first anode material is chosen from a group of material each of which are know to produce a porous insulating layer when subjected to electric discharges from a cathode in a fluorine containing gas.

6. A laser as in claim 1 wherein said first anode material is chosen from a group of materials each of which are known to produce a porous fluoride layer when subjected to electric discharges from a cathode in a fluorine containing gas.

7. A laser as in claim 1 wherein said first anode material comprises a porous insulating layer.

8. A laser as in claim 7 wherein said porous insulating layer is comprised of a metal fluoride.

9. A laser as in claim 7 wherein said porous insulating layer is created by exposing said anode to electric discharges in a gas environment wherein gas in said gas environment comprises F₂.

10. A laser as in claim 7 wherein said porous insulating layer comprises a porous alumina layer.

11. A laser as in claim 7 wherein said porous alumina layer is an anodized aluminia layer.

12. A laser as in claim 7 where said porous insulating layer is comprised of particles comprised of an electrical insulator material.

13. A laser as in claim 12 wherein said insulator material is a ceramic.

14. A laser as in claim 12 wherein said insulator material is a fluoride.

15. A laser as in claim 12 wherein said insulator material consists of a ceramic chosen from a group consisting of Al₂O₃, MgF₂ and CaF₂.

16. A laser as in claim 7 wherein said porous insulating layer is comprised of a large number of holes.

17. A laser as in claim 7 wherein said large number of holes is in excess of 50,000.

18. A laser as in claim 16 wherein most of said large number of holes have widths of between 20 microns and 250 microns.

19. A laser as in claim 1 wherein said anode has a cross section chosen to produce a high electric field over a width, defining the discharge region of said anode, of about 3.5 mm along a centerline of said anode with a sharp decrease in the electric field on both sides of said anode discharge region.

20. A laser as in claim 1 wherein at least one of said electrode elements define a discharge surface and comprises trenches running longitudinal along two sides of said discharge surface.

21. A laser as in claim 1 and further comprising a current return structure configured to shape the discharge to a desired shape and further comprising insulating spacers to guide the gas flow through and beyond the discharge region.

22. A laser as in claim 1 wherein said porous insulating layer is comprised of insulating particles embedded in a metal.

23. A laser as in claim 22 wherein said metal is a brass.

24. A process for producing an elongated electrode for use in a laser comprising the steps of:
A) fabricating an elongated electrode structure comprised of one or more electrical conducting materials and having a long dimension of at least 50 centimeters and a width of at least 3 centimeters.
B) creating a porous insulating layer on a portion of said elongated electrode, said portion defining a discharge region having a width of at least 3 millimeters.

25. A process as in claim 24 wherein said one or more electrical conducting materials comprise a lead rich brass having a lead content of greater than 1 percent, and said step of creating said porous electrical insulating layer comprises operating said electrode in a fluorine containing laser gas to permit a porous insulating layer to build up on the lead rich brass.

26. A process as in claim 24 wherein said step of creating said porous insulating layer comprises spreading insulating particles on the discharge region of said elongated electrode structure.

27. A process as in claim 24 wherein said step of creating said porous insulating layer comprises the steps of:
A) mixing insulating particles in a molten metal to produce a discharge section of said elongated electrode said section comprising a filler metal and said insulating particles,
B) operating said elongated electrode in a fluorine containing laser gas environment to permit a portion of said filler metal to sputter away leaving a porous insulating layer covering said discharge region.

28. A process as in claim 26 wherein said insulating particles have dimensions in the range of about 50 to 150 microns.

29. A process as in claim 27 wherein said particles have dimensions in the range of about 50 to 150 microns.

30. A laser as in claim 1 wherein said cathode is comprised of:
A) a first cathode material, defining a first cathode erosion rate, located at said long narrow discharge region of said cathode said region defining two long edges and,
B) a second cathode material, defining a second cathode erosion rate, located on at least two sides of said long narrow discharge region of said cathode along said two long edges and adjacent to said long narrow discharge region of said cathode, wherein said first and second cathode materials are chosen such that the second cathode erosion rate is at least 50 percent greater than the first cathode erosion rate so that during operation of said laser greater erosion rate of said second cathode material prevents any substantial long-term widening of said discharges.

31. A laser as in claim 30 wherein said first cathode material comprises C26000 brass and said cathode material comprises C36000 brass.

32. A laser as in claim 30 wherein said first cathode material and said second cathode material each define an average grain size of said first cathode material is less than 70 percent than the average grain size of said second cathode material.

33. A laser as in claim 32 wherein said first cathode material is annealed to a greater extent than said second cathode material.

34. A laser as in claim 30 wherein first and second cathode materials are chosen such that first and second cathode materials are chosen such that said second cathode erosion rate is at least four times said first cathode erosion rate.

35. A laser as in claim 1 wherein first and second anode materials are chosen such that first and second anode materials are chosen such that said second anode erosion rate is at least four times said first anode erosion rate.

36. A laser as in claim 30 wherein first and second cathode materials are chosen such that first and second cathode materials are chosen such that said second cathode erosion rate is at least ten times said first cathode erosion rate.

37. A laser as in claim 1 wherein first and second anode materials are chosen such that first and second anode materials are chosen such that said second anode erosion rate is at least ten times said first anode erosion rate.
